(19) United States
(12) Patent Application Publication
(10) Pub. No.: US 2019/0035263 A1
(43) Pub. Date: Jan. 31, 2019

(54) TRAFFIC LIGHT SYSTEM WITH IMPROVED SAFETY MEASURES

(71) Applicant: Manasse LOES, ZION, IL (US)

(72) Inventor: Manasse LOES, ZION, IL (US)

(21) Appl. No.: 15/664,498

(22) Filed: Jul. 31, 2017

(51) Int. Cl. G08G 1/005; G08G 1/095

(52) U.S. Cl. CPC G08G 1/005; G08G 1/095

(57) ABSTRACT

Disclosed is a traffic light system having improved safety measures for alerting pedestrians and vehicle drivers in proximity to prevent accidents. The traffic light system includes a red, yellow and green traffic signal lights automatically controlled using a control unit, a speaker module in communication with the control unit for generating one or more pre-recorded audio signals and an alarm sound during an ON or OFF operation of each of the traffic lights and a power supply unit for powering the operations of the traffic lights, the control unit and the speaker module. The speaker module is a detachable modular unit having a volume control means to adjust a volume level of the alarm sounds and the pre-recorded audio signals to a desired level for alerting pedestrians and vehicle drivers in proximity.

### CROSS REFERENCE TO RELATED APPLICATIONS

Not applicable

### FEDERALLY SPONSORED RESEARCH AND DEVELOPMENT

Not applicable.

### MICROFICHE

Not applicable

### BACKGROUND OF THE INVENTION

### Field of the Invention

The present invention relates generally to traffic light systems, more specifically, to a traffic light system with audible alarms for alerting blind or visually impaired or careless pedestrians and vehicle drivers.

### Description of the Related Art

The traffic light plays an important role in urban transport, especially road junctions sidewalk traffic lights, can direct people to safety across the street. However, one of the leading causes of death around the world is road-related accident. While some road accidents occur due to poor weather conditions, most of these accidents are caused by human error. With recent advancements in electronics ad communication technology, people are often preoccupied with their smartphones most of time such as during walking, sitting or whenever they gets an interval during their usual activities. Existing traffic lights installed at the intersections provides visual indication to the pedestrians and the vehicle drivers to start or stop. Most of the people including pedestrians and drivers at an intersection installed with traffic light visual indications ignore the traffic light or a change in the traffic signal, as they don't realize that the traffic light has already changed due to their focus towards their smartphones for making phone call, texting, checking emails, etc. Most of the time this ignorance lasts until someone behind or nearby the pedestrian or vehicle driver makes a noise. Then these people wake up and realizing that the signal has changed, they suddenly starts walking or driving without paying attention, which results in personnel injuries to pedestrians and vehicle drivers, vehicle damage and sometimes deaths. Hence there exists a need for an improved traffic control system, which would be able to alert pedestrians and vehicle drivers upon changing a traffic light signal. Moreover the needed system would change the focus of personnel including pedestrians and vehicle drivers to the road while at an intersection.

Several prior arts exist which provide different traffic signal means for alerting people around. One such system is disclosed in U.S. Pat. No. 8,274,404 B2, titled “Devices and Methods for Controlling a Change of a Status of Traffic Light at a Crosswalk”, issued to Sennett Dewayne and Brian Daly. In the above prior art, the change of the status of a traffic light at a crosswalk is controlled based on an impaired individual's location with respect to the crosswalk. An appropriate alert indicating the status of the traffic light is determined based at least on the location of the impaired individual. The type of impairment may also be used in determining the appropriate alert. The appropriate alert is generated to inform the impaired individual of the status of the traffic light. However the above method is not effective for preventing road accidents at traffic light intersections caused by unfocussed pedestrians and vehicle drivers.

Another prior art, U.S. Pat. No. 6,127,943 A, titled “Audible traffic signal for visually impaired persons using multiple sound outputs”, issued to Koito Industries, Ltd. discloses an audible traffic signal adding apparatus for visually impaired persons. The audible traffic signal adding apparatus includes two speakers and a control section. The two speakers are disposed at two ends of a crosswalk. The control section navigates a visually impaired person crossing the crosswalk by alternately outputting different sounds as in “back and forth call” operation from the two speakers disposed at the two ends of the crosswalk to the visually impaired person for a period during which crossing is permitted. However the above method is not effective for preventing road accidents at traffic light intersections caused by unfocussed pedestrians and vehicle drivers.

Another prior art, WO 2004044333 A1, titled “Illuminated signalling device for pedestrian crossings”, filed by Cordeiro Vilan Xesus, discloses an illuminated signaling device for pedestrian crossings. The device includes a support which is fixed to the pavement and which is used to house all of the mechanisms necessary for the operation thereof. The invention also comprises a timed push button which is disposed on the aforementioned support at a height of approximately one metre above the ground and which is used to start the device. The upper part of the support comprises an illuminated panel displaying the graphic signal, which indicates the existence of a pedestrian crossing. Moreover, the rear of said illuminated panel is designed such that an acoustic system for the visually impaired can be installed, which is activated simultaneously with the illuminated panel. The inventive device is preferably connected to the low-voltage network of the public thoroughfare or, under other circumstances, mechanisms for the use of alternative energy sources can be installed. However the above method is not effective for preventing road accidents at traffic light intersections caused by unfocussed pedestrians and vehicle drivers.

Hence there exists a need for a system, which would prevent road accidents caused by unfocussed pedestrians and vehicle drivers at traffic light controlled intersections. The needed system would further provide audio assistance for blind people to cross the road. The needed system would easily be configurable based on various conditions at the intersection. Further the needed system would be easily installed at existing traffic light controlled intersections and new traffic light signal installations alike.

### SUMMARY OF THE INVENTION

The present invention relates to a traffic light system having improved safety measures for alerting pedestrians and vehicle drivers in proximity. The traffic light system for providing improved safety measures to the pedestrians and vehicle drivers includes a traffic light signal, installed at an intersection, having a number of traffic lights for controlling the traffic at the intersection of roads. The traffic lights produce red, yellow and green colored lights for controlling the traffic. Further the traffic light system includes visual assisting means, such as an LED display, for assisting the pedestrians to cross the roads. The present traffic light system provides an additional assisting means in form of audio signals with alarm sounds for alerting the pedestrians and the vehicle drivers near the intersection. The present traffic light system with visual and audio signals assists the normal people and visually impaired or blind people crossing the roads and alerts the nearby drivers about the traffic signal change. Hence the present traffic light system prevents accidents at the intersections due to negligence from the pedestrians or vehicle drivers.

According to an exemplary embodiment, the present traffic light system having improved safety measures for alerting pedestrians and people in proximity further includes a control unit for automatically controlling an ON and OFF operation of each of the red, yellow and green traffic lights and the information displayed through LED/LCD/7-Segment display screens. A speaker module is provided with the traffic lights, which is in communication with the control unit for generating one or more pre-recorded audio signals and alarm sounds during the ON or OFF operation of each of the traffic lights. The pre-recorded audio signals include STOP, CAUTION and GO audio signals and alarm sounds that are played through the loudspeaker at an audio level, loud enough to attract the attention of the pedestrians, people nearby and the drivers of the vehicle at the intersection. The present traffic light system is powered using a power supply module having a rechargeable battery unit.

According to another exemplary embodiment, the present traffic light system includes a processor for processing information including real-time traffic data, pedestrian data and other information for automated control of the traffic light signal including the audio signal and alarm sounds from the speaker module. The control unit further includes a memory unit for storing a variety of data including instructions for processing the real-time traffic data, pedestrian data, other relevant information and the pre-recorded audio signals including STOP, CAUTION and GO audio signals and alarm sounds. An LED controller in communication with the processor controls the light output or the ON and OFF operation of the RED, YELLOW and GREEN traffic lights. The processor processes the real-time traffic data, pedestrian data and other information received from a number of sensors and camera units and calculates the time interval between ON and OFF periods of the traffic lights and the audio signal and the alarm sounds from the speaker module.

According to another exemplary embodiment, the present traffic light system includes a processor for processing information including a timer data for automated control of the traffic light signal including the audio signal and the alarm sounds from the speaker module based on the preset time delays in the timer unit. The processor receives the time delay information from the timer unit and signals the LED controller to perform ON and OFF operation of the traffic lights based on the timer delay period. At the same instant the processor instructs the speaker module to play the pre-recorded audio signals including STOP, CAUTION and GO audio signals and alarm sounds based on the same time delay preset in the timer unit.

According to another exemplary embodiment, the present traffic light system includes a timer unit, which would allow operator to set a time delay for each of the traffic light at the intersection. The traffic lights are switched ON and OFF based on the preset timer delay period. At the same instant, the speaker module plays the pre-recorded audio signals including STOP, CAUTION and GO audio signals and alarm sounds based on the same time delay preset in the timer unit.

According to another exemplary embodiment, the present traffic light system includes a detachable modular speaker module that can be attached to existing traffic light signals and can also be integrated to new traffic light signals. The modular speaker module includes a loudspeaker for playing audio signals and loud alarm sounds for getting attention of the pedestrians and other vehicle drivers at the intersection. The modular speaker module further includes a volume control means, which can be control automatically or manually, to control a volume output of the audio signals and loud alarm sounds at the intersection for proper alerting of the passerby, pedestrians and other vehicle drivers at the intersection. In some other instances, the modular speaker module comes with an in-built battery and is portable to attach with any desired traffic signal light. Further the modular speaker module includes a microphone to sense the noise level at the intersection, where it is installed, and the audio signal and alarm sound output volumes are automatically increased to provide alerts at high volume to the pedestrians and other vehicle drivers at the intersection. In some other instances, the audible signal from the modular speaker module is preceded by the alarm sound for getting proper attention from the pedestrians and other vehicle drivers at the intersection.

These together with other objects of the invention, along with the various features of novelty, which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

To further clarify various aspects of some example embodiments of the present invention, a more particular description of the invention will be rendered by reference to specific embodiments thereof that are illustrated in the appended drawing. It is appreciated that the drawing depicts only illustrated embodiments of the invention and are therefore not to be considered limiting of its scope. Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness. The invention will be described and explained with additional specificity and detail through the use of the accompanying drawing in which:

FIG. 1 is a schematic representation of the present traffic light system having improved safety measures for alerting pedestrians and people in proximity, according to a preferred embodiment of the present invention;

FIG. 2 illustrates a basic block diagram showing a number of major components and modules of the present traffic light system having improved safety measures for alerting pedestrians and people in proximity, according to an embodiment of the present invention;

FIG. 3A illustrates a flowchart showing a method of operation of the traffic light system installed with a timer unit for assisting in alerting pedestrians and people in proximity, according to an embodiment of the present invention; and

FIG. 3B illustrates a flowchart showing a method of operation of the traffic light system installed with real-time traffic sensor devices for assisting in alerting pedestrians and people in proximity, according to an alternate embodiment of the present invention.

### DETAILED DESCRIPTION OF THE INVENTION

In the following detailed description, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural, logical, electrical and other changes may be made without departing from the spirit and scope of the present invention. The following detailed description is, therefore, not to be taken in a limiting sense, and the scope of the present invention is defined by the appended claims and their equivalents.

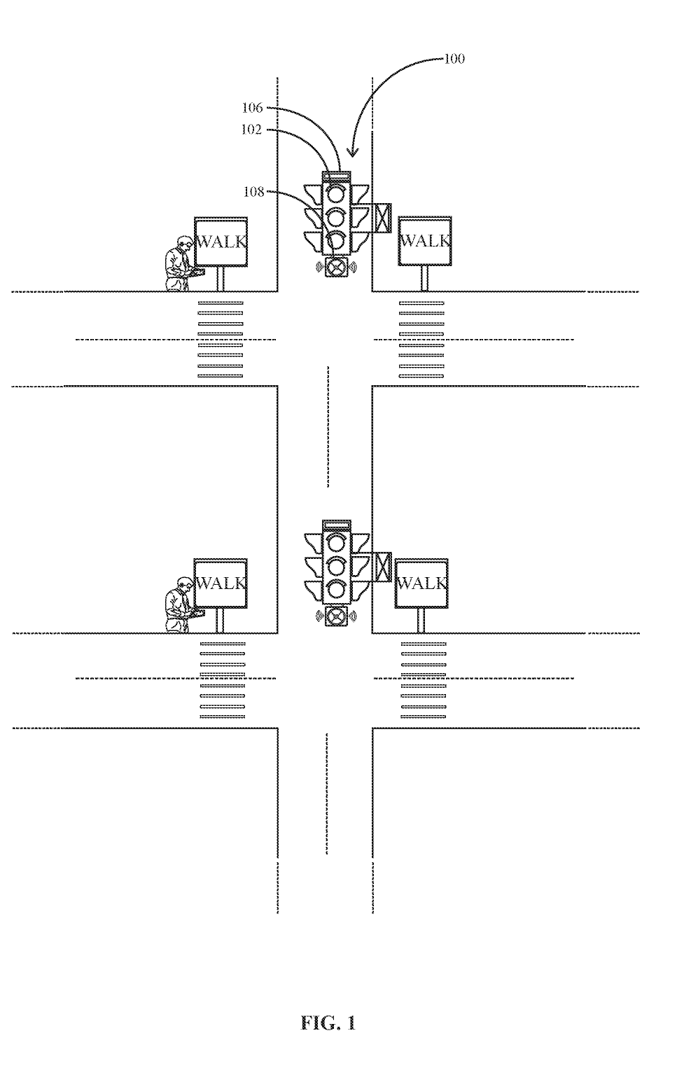

The present invention relates to a traffic light system having improved safety measures for alerting pedestrians and people in proximity and thereby preventing accidents, according to a preferred embodiment of the present invention. FIG. 1 is a schematic representation of the present traffic light system 100 having improved safety measures for alerting pedestrians and people in proximity, according to a preferred embodiment of the present invention. The traffic light system 100 for providing improved safety measures to the people and drivers includes a traffic light signal post, installed at an intersection, having a number of traffic lights 102 for controlling the traffic at the intersection of roads. The traffic lights 102 produces RED, YELLOW and GREEN colored lights, where the red light is for stopping vehicles, yellow for giving caution to the drivers and green for allowing the drivers to go in a particular direction. In most of the intersection of roads, there are provisions, in form of zebra lines, for allowing the pedestrians to cross the roads. The pedestrians are allowed to cross the road when the vehicles passing through the road on either direction are stopped using the traffic lights 102. In some instances, there are manually operable buttons, provided within reach of the pedestrians, for allowing the pedestrians to press or activate in order to make necessary adjustment to the traffic light signals to allow them to pass. In some other instances, there are automated sensor systems, either electronic sensor based or based on an image analysis process, which processes the images from a camera at the traffic signal to identify the pedestrian crowd size, to control the operation of the traffic light signals to allow the pedestrians to pass. However in most of the instances, the pedestrians do not have an easy access to control the traffic light signal. In order for a pedestrian to cross a road at an intersection, he/she has to wait for the traffic light 102 to turn RED for stopping the passage of vehicles through that road, and then he/she can safely cross the road to reach the other point. However, with the advancement in communication technologies and Internet, people may be continuously engaged with their electronic gadgets during walking or at the stopping times at an intersection and often fails to notice the sudden changes in the traffic light signal. This negligence from the pedestrians or drivers causes several accidents to that person and other passersby. The present traffic light system 100 provides an optimal solution to solve this problem by alerting the people near the intersection having the traffic light with loud audible sound signals played along with the traffic light signal changes. In some other embodiment, the present traffic light system 100 alerts the people near the intersection having the traffic lights 102 with loud audible sound signals accompanied by loud alarm sounds or either one among the loud audible sound signals and the loud alarm sounds.

The present traffic light system 100 having improved safety measures for alerting pedestrians and people in proximity further includes a control unit 104 for automatically controlling an ON and OFF operation of each of the RED, YELLOW and GREEN traffic lights 102 and the information displayed through one or more light emitting diode (LED) or liquid crystal display (LCD) or seven segment display screens 106. A speaker module 108 is provided with the traffic lights 102, which is in communication with the control unit 104 for generating one or more pre-recorded audio signals and loud alarm sounds during the ON or OFF operation of each of the traffic lights 102. The speaker module 108 includes a loudspeaker 110, an audio driver unit 112, a volume control means 138 and a memory unit 114. The memory unit 114 stores the pre-recorded audio signals and the alarm sounds. In a preferred embodiment, the pre-recorded audio signals including STOP, CAUTION and GO audio signals are played through the loudspeaker 110 at an audio level or volume, loud enough to attract the attention of the pedestrians, people nearby and the drivers of the vehicle at the intersection. In some other embodiment of the present invention, the pre-recorded audio signals including STOP, CAUTION and GO audio signals and one or more loud alarm sounds are played through the loudspeaker 110 at an audio level or volume, loud enough to attract the attention of the pedestrians, people nearby and the drivers of the vehicle at the intersection. In some instances, the loud alarm sounds are played prior to or along with the pre-recorded audio signals. In a preferred embodiment, the control unit 104 signals the speaker module 108 to play STOP audio signal and the alarm sound at a loud volume when the traffic light is turned on to show RED color. Similarly the control unit 104 signals the speaker module 108 to play CAUTION audio signal and the alarm sound when the traffic light is turned on to show YELLOW color and the control unit signals the speaker module to play GO audio signal and the alarm sound when the traffic light is turned on to show GREEN color.

The control unit 104 controls the ON and OFF operations of the traffic lights 102 and signals the speaker module 108 to play the pre-recorded audio signal and the alarm sound during a change in traffic light color, i.e. from GREEN to YELLOW and YELLOW to RED and RED to GREEN for alerting the pedestrians and people in proximity regarding the change in the traffic light signal. This enables the pedestrians, people nearby and the drivers of the vehicle at the intersection to pay attention to the road and the traffic light signal and thereby ensuring safe driving and roads crossing at the intersections. The present traffic light system 100 further includes a power supply module 116 for powering the operations of the traffic lights 102, the control unit 104, the speaker module 108 and other electronic devices associated with the traffic lights signal.

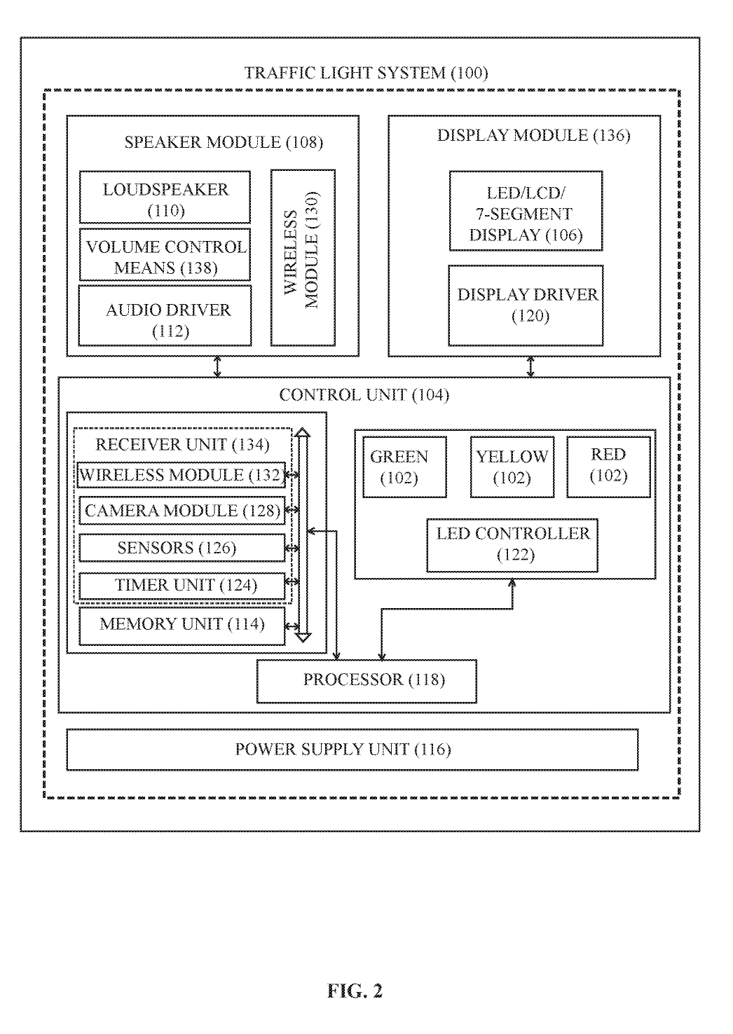

FIG. 2 illustrates a basic block diagram showing a number of major components and modules of the present traffic light system 100 providing improved safety measures for alerting pedestrians and people in proximity, according to an embodiment of the present invention. The traffic light system 100, according to an embodiment of the present invention includes an embedded electronic system having a processor 118 for processing a plurality of information including real-time traffic data, pedestrian data and other information for automated control of the traffic light signal. The embedded electronic system for controlling the traffic light signals is the control unit 104, which further includes a memory unit 114 for storing a variety of data including instructions for processing the real-time traffic data, pedestrian data and other information. The memory unit 114 further stores a number of pre-recorded audio signals including STOP, CAUTION and GO audio signals corresponding to each of the traffic lights 102 with RED, YELLOW and GREEN colors, respectively and one or more alarm sounds to get the pedestrian's or vehicle driver's attention. An LED controller 122 in communication with the processor 118 controls the light output or the ON and OFF operation of the RED, YELLOW and GREEN traffic lights 102. The control unit 104 for controlling the traffic light signals further includes a timer unit 124 for controlling the ON and OFF periods of the traffic lights 102 including the RED, YELLOW and GREEN traffic lights. The timer unit 124 or the memory unit 114 is preset or fed with a preset time schedule or delay period for controlling the ON and OFF periods of the traffic lights 102. In some instances, the processor 118 processes the time interval information or delay period obtained from the timer unit 124 and/or the memory unit 114 to automatically control the ON and OFF periods of the traffic lights 102. In some other instances, the timer unit 124 directly controls the ON and OFF periods of the traffic lights 102.

The control unit 104 further includes a number of sensors 126 such as vehicle density sensor, which provides the real-time information about the approximate number of vehicles at the intersection waiting for the traffic signals. In some embodiment, the sensors 126 are placed a bit far from the traffic lights 102, to calculate the real-time status of the vehicle count at the intersection. The sensors 126 may include induction type sensors, visual analysis sensors, other form of commonly used sensors for detecting the approximate number of vehicles at the traffic intersection, etc. The control unit 104 in communication with the processor 118 further includes a camera module 128 for capturing the real-time images of the vehicles and pedestrians at the intersection. The memory unit 114 includes processor executable program codes for analyzing the real-time images of the vehicles and pedestrians at the intersection and thereby dynamically controlling the traffic lights 102 and the audio signal and alarm sound generated from the speaker module 108. The processor 118 processes the instructions for processing the real-time images of the vehicles and pedestrians and instructs the LED controller 122 to control the ON and OFF periods of the traffic lights 102 and at the same time instructions are given to the speaker module 108 to play pre-recorded audio signals such as, STOP, CAUTION and GO audio signals corresponding to each of the traffic lights 102 with RED, YELLOW and GREEN colors with the alarm sound for receiving people's attention.

The timer unit 124, the sensors 126, the camera module 128 and the wireless module 132 forms a part of the receiver unit 134, which is capable of receiving data from external devices and external sensors for controlling the operation or the ON and OFF periods of the traffic lights 102. The present traffic light system 100 can be implemented in different types of traffic light systems. For example, the present traffic light system 100, according to some embodiment, include built-in sensors 126 with the traffic lights 102 and the speaker module 108 and are installed at the intersections for detecting the vehicles and pedestrians at the intersection and thereby dynamically controlling the traffic lights 102 and the audio signals and alarm sounds generated from the speaker module 108. However, in some other embodiment, the present traffic light system 100, include built-in cameras or camera module 128 with the traffic lights 102 for detecting the vehicles and pedestrians at the intersection by analyzing the images and thereby dynamically controlling the traffic lights 102 and the audio signal accompanied with alarm sounds generated from the speaker module 108. However, in some other embodiment, the present traffic light system 100, include a wireless module 132 for communicating with a number of external sensors such as, but not limited to, traffic detectors, sensors, infrared sensor, inductive loop, magnetometer, video image processor, microwave radar sensor, laser radar sensor, acoustic sensor, ultrasonic sensor, magnetic sensor, etc. The wireless module 132 associated with the traffic lights 102 and the speaker module 108 installed at the intersections sends the information to the processor 118 for further processing to determine real-time vehicles and pedestrians information at the intersection by analyzing the images and thereby dynamically controlling the traffic lights 102 and the audio signal and alarm sound generated from the speaker module 108. However, in some other embodiment, the present traffic light system 100 and the associated traffic lights 102 and the speaker module 108 installed at the intersections receives instructions from the processor 118 based on preset timer values or preset delay periods in the timer unit 124 to control the audio outputs, i.e. the audio signals and the alarm sounds, from the speaker module 108 and the corresponding light signals from the traffic lights 102 as discussed in above paragraphs.

In some embodiment, the present traffic light system 100 includes a display module 136 having a LED/LCD/7-Segment display 106 with the traffic lights 102 provided at the intersections and a display driver 120 to process the information to be displayed on the LED/LCD/7-Segment display 106. The LED backlit display screen 106 is controlled using the display driver 120 for displaying a variety of information in form symbols and text. The processor 118 executes a number of instructions from the memory unit 114 or instructions received from through the wireless module 132 and instructs the display driver 120 to display the processed information on the LED/LCD/7-Segment display 106. The information displayed through the LED/LCD/7-Segment display 106 include timer or counter values at the intersection, ‘stop’ and ‘go’ symbols for pedestrians and vehicles, and other relevant information. The display module 136 is generally arranged on top or bottom or as a separate unit from the traffic lights 102 installed at the intersections. The audio signals with the alarm sound and the display information further alert the pedestrians and the vehicle drivers at the intersection thereby preventing the accidents at the intersections.

In some other embodiment, the present traffic light system 100 includes the speaker module 108 having the loudspeaker 110, audio driver 112, volume control means 138 and a wireless communication module 130. The audio signals such as, STOP, CAUTION and GO audio signals and alarm sounds to be played during switching ON of each of the RED, YELLOW and GREEN traffic lights 102 are stored in the memory unit 114. The timing for switching ON and OFF the RED, YELLOW and GREEN traffic lights are controlled using the above-discussed methods. In each method, the audio signals, such as, STOP, CAUTION and GO audio signals and the alarm sound are played at a high volume during switching ON operation of the RED, YELLOW and GREEN lights, respectively. The volume of the audio signals and the alarm sound are maintained at a high level, adequate to alert the pedestrians and the vehicle drivers at the intersection. Each time when the processor 118 instructs the LED controller to turn on RED traffic light 102, the processor 118 also instructs the audio driver 112 associated with the speaker module 108 to process the STOP audio signal and a specific alarm sound and play through the loudspeaker 110. Similarly, when the processor 118 instructs the LED controller to turn on YELLOW and GREEN traffic light 102, the processor 118 instructs the audio driver 112 associated with the speaker module 108 to process the CAUTION and GO audio signals and a specific alarm sound to play through the loudspeaker 110 to alert the pedestrians and the vehicle drivers at the intersection. In some instances, the speaker module 108 is instructed to play the alarm sound first to get everyone's including pedestrians and vehicle drivers at the intersection attention followed by the audio signal related to the traffic light 102 that is active or shortly going to be active at that time.

The present traffic light system 100 with synchronized traffic lights 102 and audio signals and alarm sounds helps to considerably reduce the accidents at intersection by alerting both the pedestrians and the vehicle drivers alike. In some other embodiment, the speaker module 108 is placed at a distant location, may be across the road or on both sides of the road, to alert the pedestrians on both sides. In such cases, the speaker module 108 is installed with wireless communication module 130, which communicates with the wireless module 132 in direct communication with the processor 118 and receives instructions from the processor 118 over a wired and/or a wireless communication channel to play the relevant audio alert signals. This arrangement is more effective as the pedestrians on both sides of the road can be alerted about the change in traffic light signals.

In an embodiment of the present invention, the speaker module 108 is available in form of a detachable modular unit to removably connect with a number of existing and new traffic light installations at intersections. These speaker modules 108 available in form of the detachable modular units are provided with an in-built rechargeable battery unit. In some instances the speaker module 108 available in form of the detachable modular unit includes one or more charging port to charge from a power supply means 116 associated with the existing and new traffic light installations. The speaker module 108 in communication with the control unit 104 produce audible alerts in form of STOP, CAUTION and GO audio signals with the alarm sound to alert and thereby assist the visually impaired people, other careless pedestrians to cross the road and vehicle drivers in proximity to the traffic light signal to continue safe driving. Further the speaker module 108 includes the volume control means 138 to adjust a volume level of the alarm sounds and the pre-recorded audio signals. In some embodiment, the speaker module 108 includes a manual volume control means to manually adjust the volume level of the alarm sounds and the pre-recorded audio signals. In some other embodiment, the speaker module 108 includes an automatic volume control means to automatically adjust the volume level of the alarm sounds and the pre-recorded audio signals. The automatic volume control means 138 automatically adjust the volume level of the alarm sounds and the pre-recorded audio signals based on a noise level in proximity. For example, in a crowded intersection in cities and urban areas, the noise level may be high and in that case the speaker module 108 automatically detects the external noise using a microphone associated with the speaker module. This noise level in some instances is processed by the processor 118 to automatically increase the volume of the audio signal and the alarm sound produced during the signal light change. In some other instances, the operator can preset the volume of the speaker module 108 to a higher level in such areas thereby producing an effective alert to receive the attention of the pedestrians and the vehicle drivers. In some other instances, the control unit 104 signals the speaker module 108 to play each of the pre-recorded audio signals and the alarm sounds at a desired volume during ON or OFF operation of each of the traffic lights. In addition, the speaker module 108 is available in form of a detachable modular unit to removably connect with a number of existing and new traffic light installations. In some other embodiment of the present invention, the processor 118 associated with the control unit 104 enable wireless reception of real-time traffic data and wireless transmission of instructions to play the audio signals and the alarm sounds for alerting the pedestrians and the vehicle drivers through a remote speaker unit proximate to the traffic light signals.

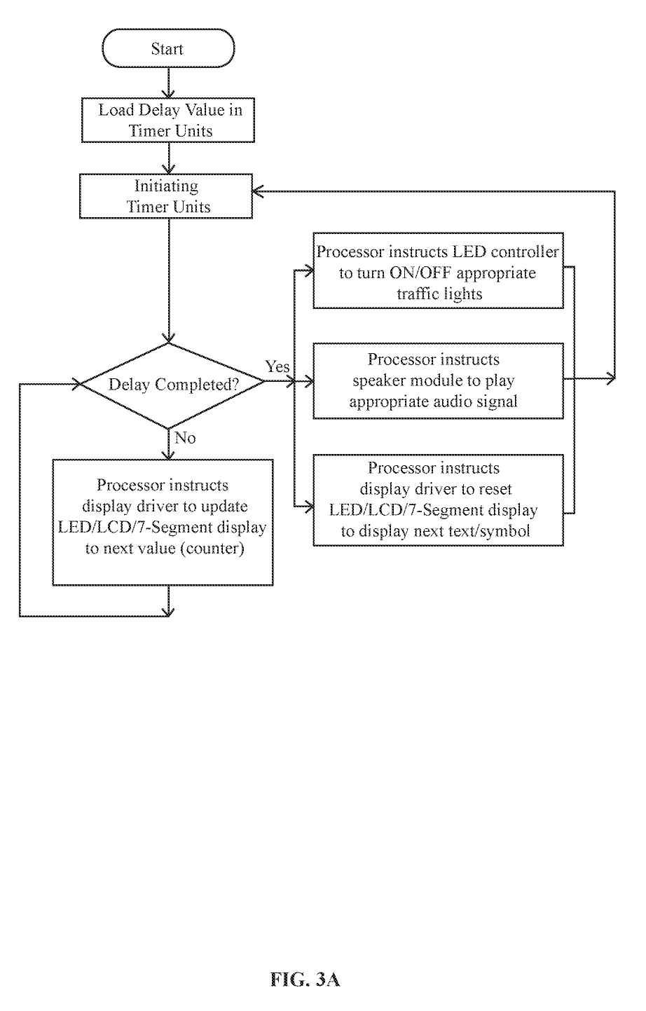

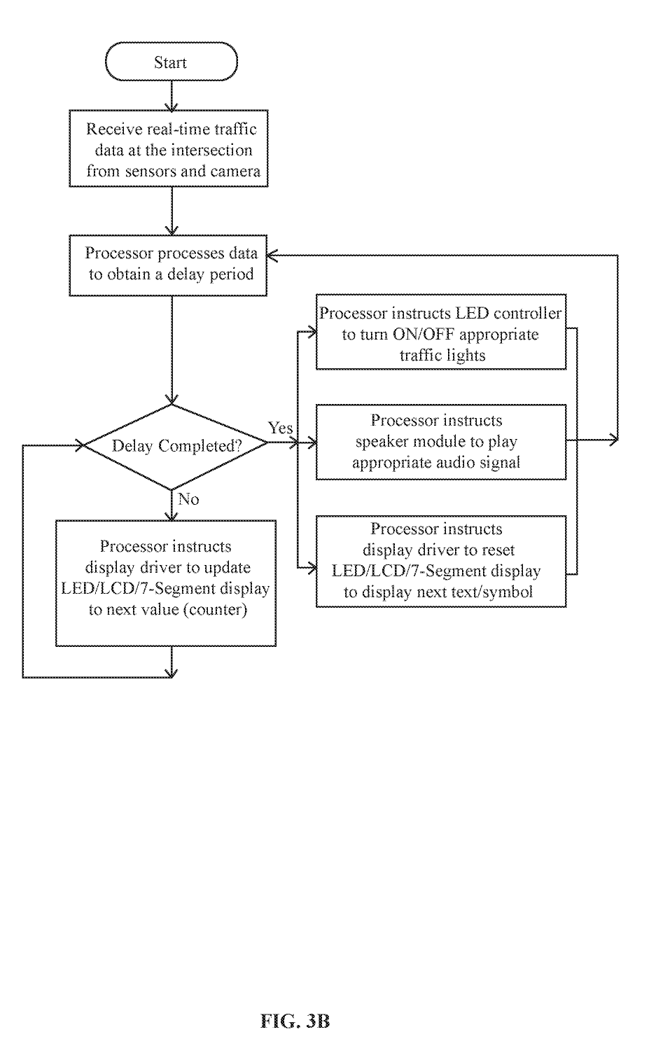

FIG. 3A illustrates a flowchart showing a method of operation of the traffic light system 100 having improved safety measures for alerting pedestrians and people in proximity, according to an embodiment of the present invention. The method includes the step of setting the timer unit 124 with delay periods for each transition of traffic light signal from RED to YELLOW to GREEN. In some embodiment, the control unit 104 includes an input/output module (not shown) for allowing the operator to connect external devices such as computer or timer configuring device for configuring the timer delay periods. In some instance, a similar timer unit is installed with the speaker module 108, which is configured based on the time delays introduced in the timer unit 108 associated with the receiver unit 134 and in communication with the processor 118. Based on the timer delay value set in the timer unit 124, the processor 118 controls the information displayed through the LCD/LED/7-segment display 106. Each of the RED, YELLOW and GREEN traffic lights turns ON once a preset delay period is reached after each traffic light signal. Since the same delay period is maintained at the speaker module 108, either through the similar timer unit or based on the instructions received from the processor 118, the audio signals such as, STOP, CAUTION and GO audio signals corresponding to the traffic signal light to be displayed is played through the loudspeaker 110.

FIG. 3B illustrates a flowchart showing a method of operation of the traffic light system 100 installed with real-time traffic sensor devices for alerting pedestrians and people in proximity, according to an embodiment of the present invention. In this embodiment, the timer unit 124 is replaced by real-time traffic data analyzing systems incorporating the sensors 126, camera module 128 and other external sensor and real-time traffic and pedestrian data receiving means. In such an instance, the RED, YELLOW and GREEN traffic lights 102 are turned ON and OFF based on the information received from the above sensors and camera. The processor 118 processes all the information and calculates the delay requirement for each traffic light 102 and instructs the audio driver 112 to play the appropriate audio signal during each transition. In all the discussed systems, all the devices associated with the traffic lights 102, including the processor, LED display 106, speaker module 108, etc. are powered using the power supply unit 116 integrated with the traffic light system 100. The power supply unit 116 includes a rechargeable battery unit power using renewable energy supply source including a solar panel or a conventional electric supply enabling continuous operation of the traffic light system 100. The present traffic light system 100 is useful for all personnel including visually impaired and blind people who can listen to the audible alerts in form of STOP, CAUTION and GO audio signals to follow the traffic signals, thereby minimizing chances of accidents.

Further, it should be noted that the steps described in the method of use could be carried out in many different orders according to user preference. The use of “step of” should not be interpreted as “step for”, in the claims herein and is not intended to invoke the provisions of 35 U.S.C. § 112, (6). Upon reading this specification, it should be appreciated that, under appropriate circumstances, considering such issues as design preference, user preferences, marketing preferences, cost, structural requirements, available materials, technological advances, etc., other methods of use arrangements such as, for example, using different sounds and music with the audio signals within above-mentioned list, elimination or addition of certain steps, including or excluding certain maintenance steps, etc., may be sufficient.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

1-20. (canceled)

21. A traffic light system having improved safety measures for alerting a pedestrian and vehicle driver in proximity thereof, comprising:
a) a traffic light having components producing red, yellow and green colored traffic lights;
b) a control unit for automatically controlling an ON and OFF operation of each of the of red, yellow and green traffic lights to sequentially control the red, yellow and green traffic lights operation;
c) a speaker module in communication with the control unit having electoral components that generate a pre-recorded audio sounds and an alarm sound during the ON or OFF operation of each of the of red, yellow and green traffic lights;
d) a power supply unit for powering a traffic light system;
characterized in that the control unit controls the ON and OFF operations of the red, yellow and green colored traffic lights and communicates with the speaker module to generate the pre-recorded audio sounds and the alarm sound during the sequential control of the red, yellow and green traffic lights operation for alerting the pedestrian and vehicle driver in proximity thereof.

22. The traffic light system of claim 1, wherein the plurality of pre-recorded audio signals include STOP, CAUTION and GO audio sound;
wherein the control unit activates the speaker module to play the STOP audio sound when the traffic light is turned on to activate the RED traffic light;
wherein the control unit signals the speaker module to play CAUTION audio sound when the traffic light is turned on to activate the YELLOW traffic light; and
wherein the control unit signals the speaker module to play GO audio sound when the traffic light is turned on to activate the GREEN traffic light.

23. The traffic light system of claim 1, wherein the speaker module includes a volume control to adjust a volume level of the loudness of the pre-recorded audio sound.
